(19) United States
(12) Patent Application Publication
(10) Pub. No.: US 2009/0100072 A1
(43) Pub. Date: Apr. 16, 2009

(54) CONTENTS FILE PROCESSING DEVICE FOR MOUNTING IN VEHICLE

(75) Inventors: Hideo Shimoshimano, Tokyo (JP); Nobuyuki Hotta, Tokyo (JP); Yoshiharu Kuwagaki, Tokyo (JP); Takeshi Hijikata, Tokyo (JP)

Correspondence Address: ERIC ROBINSON, PMB 955, 21010 SOUTHBANK ST., POTOMAC FALLS, VA, 20165, US

(73) Assignee: KABUSHIKI KAISHA KENWOOD, Hachiouji-shi, Tokyo (JP)

(21) Appl. No.: 12/297,383

(22) PCT Filed: Apr. 27, 2007
(86) PCT No.: PCT/JP2007/059543

§ 371 Date: Oct. 16, 2008

(30) Foreign Application Priority Data
Apr. 28, 2006 (JP) 2006-126527
Jun. 5, 2006 (JP) 2006-156137

(51) Int. Cl. G06F 17/30

(52) U.S. Cl. 707/10; 707/E17.01

(57) ABSTRACT

A contents file processing device for mounting in a vehicle, having name acquisition means for acquiring a name relating to a roadside device, downloading means for downloading a specified contents file from a predetermined server through the roadside device, and storage means for storing the contents file, downloaded by the downloading means, so that the file is associated with the name acquired by the name acquisition means.

### CROSS-REFERENCES TO RELATED APPLICATIONS

These applications also claim the benefit of priority from Japanese Patent Applications No. 2006-126527 filed on Apr. 28, 2006 and No. 2006-156137 filed on Jun. 5, 2006, the entire contents of which is incorporated herein by reference.

### TECHNICAL FIELD

The present invention relates to a contents file processing device for mounting in a vehicle capable of reproducing contents downloaded from a predetermined server through a roadside device, a program for causing a computer to function as the contents file processing device and a contents file processing method using the contents file processing device. More specifically, the present invention relates to a contents file processing device for mounting in a vehicle that downloads contents files of a plurality of categories, for example, using DSRC (Dedicated Short Range Communication), and a contents file processing method and a program therewith.

### BACKGROUND ART

In recent years, attention has been given to the distribution service of contents using DSRC (Dedicated Short Range Communication) with a high transmission speed of 5.8 GHz band. In addition, high multifunctionality with hard disk in a car navigation system has advanced and hence an environment for contents distribution to vehicles is now being established. Accordingly, it is estimated that the market of contents distribution business to vehicles will become large, and various types of proposals have been made, as disclosed by Japanese Patent Application Laid-Open No. 2003-298495.

For road stations such as service areas or information provision services for various types of facilities, DSRC utilization has been proposed. There have been various types of proposals, for example, when a vehicle is parked in a service area where a roadside device is installed, IP connection of the roadside device with a device mounted in a vehicle allows information of an area periphery thereof to be viewed in the vehicle through a browser or downloading contents such as music and images allows playback in the vehicle.

Further, to meet these requests, a guideline on DSRC has been prepared. (Refer to “Narrowband communication (DSRC), fundamental application interface specification, guideline”, [online], Nov. 22, 2005, ITS Information Communication Promotion Meeting, [retrieved on Apr. 11, 2006], Internet <URL: http://www.itsforum.gr.jp/Public/J7Database/p27/ITSFOR UM_RC004_V1_{—}0.pdf>, etc.)

Japanese Patent Application Laid-Open No. 2003-298495 discloses that a terminal (reference characters 6a, 6b in FIGS. 7, 8, Japanese Patent Application Laid-Open No. 2003-298495) installed in an automobile includes a contents reproduction unit (reference numeral 25 in FIGS. 7 and 8) and contents such as music are downloaded from a DSRC base station (corresponds to the roadside device herein. Reference numeral 2 in FIG. 2, Japanese Patent Application Laid-Open No. 2003-298495), recorded in a contents record unit (reference numeral 20 in FIGS. 7 and 8) and reproduces the recorded contents in the contents reproduction unit.

The contents file downloaded from a roadside device is recorded to a recording medium such as a hard disk, but a conventional contents file processing device for mounting in vehicle records just records the contents file distributed from respective roadside devices to a recording medium and does not perform any processing contributing to rationalization of a subsequent file management system at recording.

However, in downloading contents in a road station or facility at each place, if a downloaded contents file is stored with only a file name in an ordinary way, effectively using such a contents file later may become difficult. In a recording method that just records a contents file downloaded from the respective roadside devices to a recording medium, like a conventional contents file processing device for mounting in vehicle, when a user attempts to reproduce the contents file, he/she must select a desired contents file with only a file name and/or recording time as a clue and therefore the selection may be inappropriate and inefficient.

In view of the problems of the conventional art, it is therefore a first object of the present invention to store contents downloaded in a road station or facility at each place in an apparatus for mounting in vehicle, while making later easy accessibility.

According to the present invention, each contents file downloaded from each roadside device and recorded to a recording medium is set so that the file is associated with a name related to the roadside device to be managed and so that, if a user detects a desired contents file from a recording medium, the file can be detected with the name related to the roadside device as a clue.

When the contents file downloaded from the roadside device and recorded to the recording medium in this way is associated with the name related to the roadside device to be managed, some contents file may not be capable of undergoing good rationalization of file selection work at reproduction. For example, when the contents file is a music file like Japanese Patent Application Laid-Open No. 2003-298495, music is different from facilities information or regional information and is a content having no relation with an installation place of the roadside device and therefore it is more convenient for a user to detect the content with artist name or album name as a clue than the name related to the roadside device.

It is a second object of the present invention to provide a contents file processing device for mounting in vehicle capable of rationalization of later search by a user, using a name except the name related to the roadside device in a contents file downloaded from the roadside device and recorded on the recording medium, and a contents file processing method and a program therewith.

### DISCLOSURE OF THE INVENTION

To attain a first object, a contents file processing device for mounting in a vehicle according to the present invention, in which communication is established between a roadside device installed on a road side and the vehicle, comprising: a name acquisition unit for acquiring a name related to the roadside device; a download unit for downloading a specified contents file from a predetermined server through the roadside device; and a recording unit for recording the contents file downloaded by the download unit, so that the file is associated with the name acquired by the name acquisition unit.

As the contents file processing device for mounting in vehicle, for example, a navigation system which allows IP connection with a predetermined server through 5.8 GHz narrowband communication with a roadside device is applicable. As the roadside device, for example, a device for providing information from a predetermined server through 5.8 GHz narrowband communication is applicable. As the name related to a roadside device, for example, a name of a station, facility and landmark at a road on which the roadside device is installed, a name of a place on which the roadside device is installed and these names included in URL obtained through the roadside device are applicable. As contents, for example, music contents or image contents are applicable.

With this configuration, the name acquisition unit can acquire a name related to a roadside device, for example, upon a vehicle's entering a communication zone of the roadside device. A specified one of contents files capable of being downloaded through a roadside device from a determined server is downloaded by the download unit. The downloaded contents file is stored in association with a name acquired by the name acquisition unit by the file storage unit. Instruction of reproduction of the contents file stored in this way can be accepted based on the instruction of the name associated with the contents file. Accordingly, the user can make an instruction of a contents file to be reproduced with a name associated with the contents file as a clue.

According to the present invention, the contents file processing device for mounting in a vehicle is characterized in that the name acquisition unit for a file acquires a predetermined name included in a descriptive mode distributed through the roadside device as a name related to the roadside device.

According to the present invention, the contents file processing device for mounting in a vehicle is characterized in that the name acquisition unit acquires a name related to the acquired position from a map database based on the acquired position.

According to the present invention, the contents file processing device for mounting in a vehicle further, including a folder preparation unit for preparing a folder having a folder name using a name acquired by the name acquisition unit, is characterized in that the recording unit records a contents file downloaded by the download unit in a folder prepared by the folder preparation unit.

According to the present invention, the contents file processing device for mounting in a vehicle is characterized in that the folder preparation unit includes information of a date or date and time at preparation in a folder name.

According to the present invention, the contents file processing device for mounting in a vehicle is characterized in that the folder preparation unit prepares a subfolder containing information of a date or a date and time at preparation in a folder using the name and that the recording unit records the contents file for a subfolder prepared by the folder preparation unit.

According to the present invention, the contents file processing device for mounting in a vehicle, further includes a unit for arranging an icon configured based on image data or a part of image data among contents files stored in the folder on a predetermined menu screen.

To attain a second object, according to the present invention, a contents file processing device for mounting in a vehicle, in which communication is established between a roadside device installed on a road side and the vehicle, includes: a download unit for downloading a contents file and contents information of the contents file from a roadside device; a recording unit for recording a downloaded contents file to a recording medium; a category discrimination unit for discriminating a category of the contents file based on the contents information; and a file management unit for managing a contents file downloaded and recorded to a recording medium based on a category of the contents file.

According to the present invention, the contents file processing device for mounting in a vehicle is characterized in that a category of a contents file includes at least a category of an Entertainment system and a category of Information system.

According to the present invention, the contents file processing device for mounting in a vehicle is characterized in that: the file management unit manages respective contents files based on a name of a folder in which the content file is stored in the recording medium, and the file management unit makes the recording unit prepare a folder of a corresponding name for each category of a contents file and store a downloaded contents file in a corresponding folder for each category.

According to the present invention, the contents file processing device for mounting in a vehicle is characterized in that contents information about a contents file of a category for Entertainment system includes a category of a contents file and information according to a classification within the category, and the recording unit extracts a name of a class of the contents file from the contents information and prepare a folder having a class name as a folder name for a contents file of a category for an Entertainment system.

According to the present invention, the contents file processing device for mounting in a vehicle is characterized in that the recording unit hierarchy-structures a class extracted from the contents information and prepares a folder from a hierarchy structure correlated with the hierarchy structure of the class for a contents file of a category of an Entertainment system.

According to the present invention, the contents file processing device for mounting in a vehicle is characterized in that a file management system by the file management unit for a contents file of a category for an Entertainment system downloaded from a roadside device is unified with the file management system applied to a contents file of a category for an Entertainment system ripped to the recording medium from another recording medium.

According to the present invention, the contents file processing device for mounting in a vehicle is characterized in that a name of a folder storing a contents file of a category of Information system relates to a roadside device of a transmission source of the contents file.

According to the present invention, the contents file processing device for mounting in a vehicle is characterized in that the download unit downloads contents information of a contents file earlier than the contents file and downloads the contents file after the category discrimination unit detects a category of the contents file.

According to the present invention, a contents file processing method using a contents file processing device, includes: acquiring a name related to roadside device; downloading a specified contents file from a predetermined server through the roadside device; and recording a contents file downloaded during the download, associated with a name acquired during the name acquisition.

According to the present invention, a contents file processing method using a contents file processing device for mounting in a vehicle, includes: downloading a contents file and contents information of the contents file from roadside device; recording downloaded contents file to a recording medium; discriminating a category of the contents file based on the contents information; and managing an downloaded contents file recorded to a recording medium based on a category of the contents file.

According to the present invention, there is provided a program which causes a computer to execute: acquiring a name related to a roadside device; downloading a specified contents file from a specified server through the roadside device; and recording a contents file downloaded during the downloading, associated with a name acquired during the name acquisition.

According to the present invention, there is provided a program which causes a computer to execute: downloading contents file and contents information of the contents file from a roadside device; recording a downloaded contents file to a recording medium; discriminating a category of the contents file based on the contents information; and managing an downloaded contents file recorded to a recording medium based on a category of the contents file.

The present invention is configured to store a contents file downloaded through the roadside device in association with a name related to the roadside device and therefore, in reproducing a stored contents file, means for instructing the contents to be reproduced with the name associated with the contents file and related to the roadside device as clue can be provided for the user.

In addition, as a name related to the roadside device, a descriptive system, for example, acquisition of a predetermined name included in URL to be push-distributed, is made and therefore, as a predetermined name, an optional one can be included in URL, thus enhancing flexibility of the name associated with contents file.

As the name related to the roadside device, a name capable of being acquired from a map database for car navigation based on a position upon reaching a communication zone and hence such a name can be associated with the contents file.

Moreover, a folder having a folder name using the acquired name, for example, a name of a road station is prepared and the downloaded contents file is stored in the folder and therefore a desired contents file can be retrieved with the name of the road station included in the folder name as a clue.

In preparing a folder having a folder name using an acquired name, information of date or date and time at preparation is included in a folder name and therefore, even upon second stopping in a communication zone of the same roadside device, a previously prepared folder can be maintained without being erased if the date or date and time is different. In addition, if a date or date and time is different, it is not required that the name of a second folder must be made different to coexist a folder previously prepared folder and a folder prepared this time.

Moreover, in preparing a folder having a folder name using the acquired name, a subfolder of the folder having a folder name using the name is prepared as the one having a folder name of information of date or date and time at preparation, but in a case where a folder having the same name as the folder name using the name is already present, only the one having a folder name of information of date or date and time at preparation is prepared as the subfolder, and therefore even upon second stopping in a communication zone of the same roadside device, a previously prepared subfolder can be maintained without being erased if the date or date and time is different. In addition, if a date or date and time is different, it is not required that the name of a second folder must be made different to coexist a subfolder previously prepared and a subfolder prepared this time.

Means for arranging an icon configured based on image data or a part of image data among contents files stored in the prepared folder is disposed on a predetermined menu screen, thus facilitating selection of a desired folder.

The present invention enables management of contents file downloaded from a roadside device according to file management system suited to the category by eliminating a uniform file management system and hence the desired contents file can be efficiently searched by a user.

### BRIEF DESCRIPTION OF THE DRAWINGS

FIG. 1 is a block diagram illustrating a configuration of a navigation system according to one embodiment of the present invention;

FIG. 2 is a view illustrating a state in which information is provided to a navigation system in FIG. 1;

FIG. 3 is a flow chart illustrating preparation treatment of a contents storage folder in a navigation processing unit in FIG. 1;

FIG. 4 is a view illustrating an example of a folder prepared by processing in FIG. 3;

FIG. 5 is a view illustrating another example of a folder prepared by processing in FIG. 3;

FIG. 6 is a view illustrating further another example of a folder prepared by processing in FIG. 3;

FIG. 7 is a flow chart illustrating download processing of contents in a navigation processing unit of the navigation system in FIG. 1;

FIG. 8 is a flow chart illustrating contents reproduction processing in a navigation processing unit of the navigation system in FIG. 1;

FIG. 9 is a flow chart illustrating another example of downloading of contents in a navigation processing unit of a navigation system in FIG. 1;

FIG. 10 is a schematic illustrative view of contents file downloading with a roadside device;

FIG. 11 is a configurative view of an in-vehicle unit;

FIG. 12 is a flow chart for DL file storage method at DL (download) in an in-vehicle unit;

FIG. 13 is a view illustrating a folder configuration prepared in a recording unit when a contents file to be downloaded is a music file;

FIG. 14 is a view illustrating a first folder configuration example prepared in a recording unit for a contents file of a category of Information system;

FIG. 15 is a second folder configuration example prepared in a recording unit for a contents file of a category of Information system;

FIG. 16 is a third folder configuration example prepared in a recording unit for a contents file of a category of Information system;

FIG. 17 is a flow chart of a management method for DL file stored in a recording unit based on the DL file storage method in FIG. 12;

FIG. 18 is a block diagram of a contents file processing device for mounting in a vehicle;

FIG. 19 is a configurational view of a contents file including metadata;

FIG. 20 is a view illustrating a database developed with metadata of a contents file; and

FIG. 21 is a flow chart of a contents file processing method for mounting in vehicle.

### BEST MODES FOR CARRYING OUT THE INVENTION

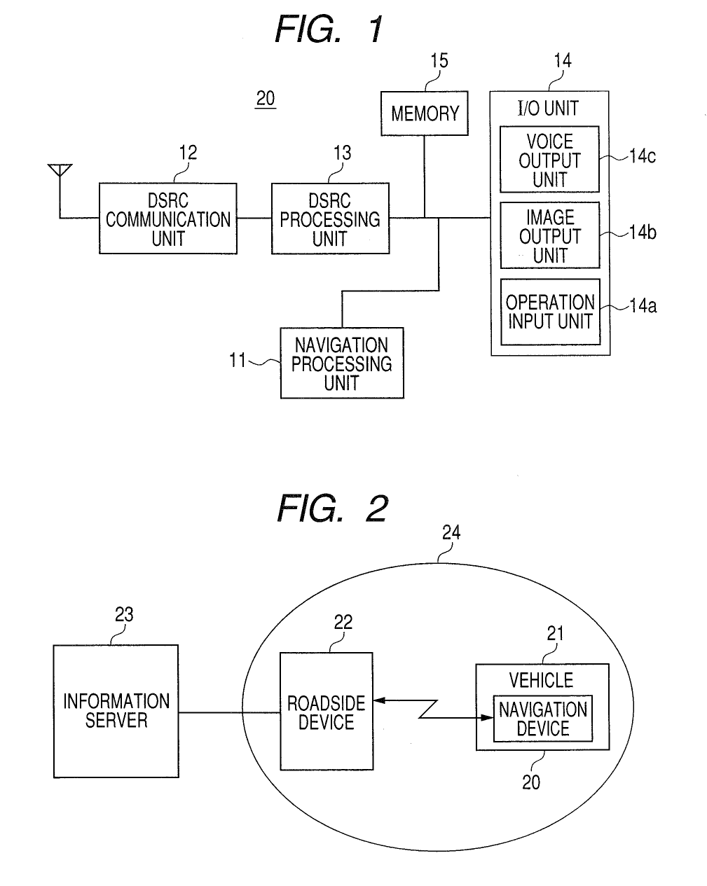

FIG. 1 is a block diagram illustrating a configuration of a navigation system according to one embodiment of the present invention. As illustrated in FIG. 1, the navigation system, having a map database and a current position detection unit (not illustrated), further includes a navigation processing unit 11 for performing various types of processing for navigation, a DSRC communication unit 12 for communicating with a DSRC roadside device, a DSRC processing unit 13 for performing demodulation for a signal received by the DSRC communication unit 12, an I/O unit 14 serving as an interface between the navigation processing unit 11, the DSRC processing unit 13 and a user, and a memory 15 for storing a downloaded contents file.

The I/O unit 14 includes an operation input unit 14a for a user to perform an operation input, an image output unit 14b for performing an output with an image and a voice output unit 14c for performing an output with a voice. The DSRC processing unit 13 has a basic application corresponding to push-type information distribution from a roadside device and corresponds to push distribution. The DSRC processing unit 13 has a function of performing point-to-point communication with the roadside device through the DSRC communication unit 12.

FIG. 2 illustrates a state in which information is provided to the navigation system in FIG. 1. Reference numeral 21 in FIG. 2 denotes a vehicle equipped with the navigation device 20 in FIG. 1, reference numeral 22 denotes a roadside device that communicates between the navigation device 20 and the roadside device, reference numeral 23 denotes a server that makes information provision through the roadside device 22 and reference numeral 24 is a communication zone as a communicatable area with the roadside device 22. The navigation processing unit 11 of the navigation device 20 has an application which is connected to the information server 23 by IP connection through the DSRC processing unit 13, the DSRC communication unit 12 and the roadside device 22 when the vehicle 21 is stopped within the communication zone 24, gains access to information owned thereby and receives request-response type information provision.

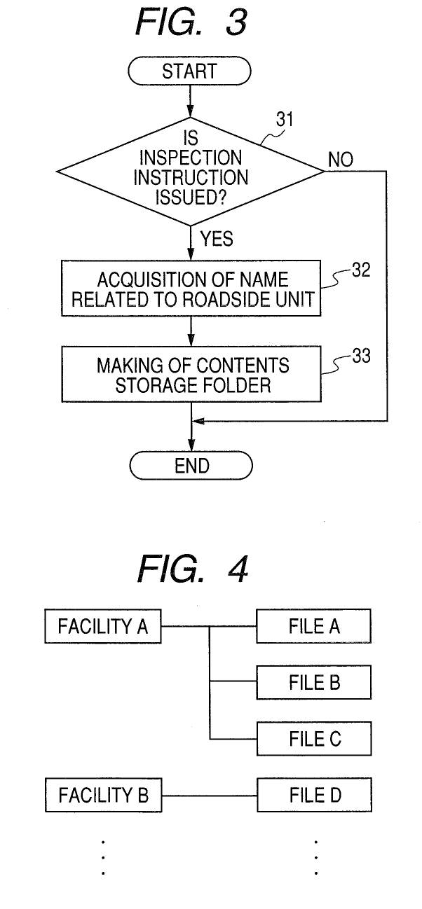

FIG. 3 is a flow chart illustrating preparation of a contents storage folder in the navigation processing unit 11. This processing is implemented after the vehicle 21 stops within the communication zone 24, a DSRC communication channel between the navigation device 20 and the roadside device 22 is established and the navigation device 20 receives URL push distribution of a start page for information provision service from the information server 23.

Specifically, the navigation processing unit 11, upon detecting that there is an instruction of information viewing in step 31, acquires a name related to the roadside device 22 in step 32. In other words, the navigation processing unit retrieves a facility existing at a current position based on the current position and map data and acquires the name of the facility as a name related to the roadside device 22.

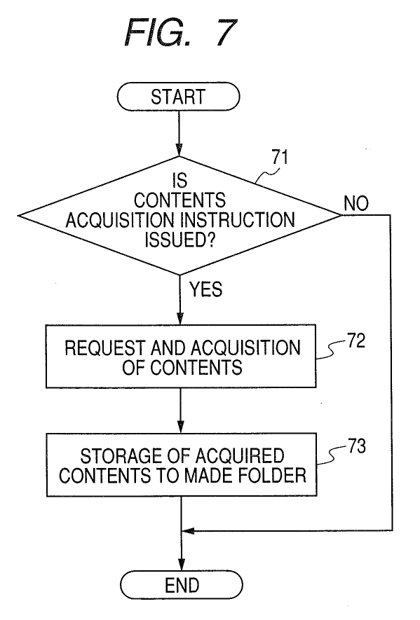

Next, in step 33, a contents storage folder is prepared. This folder stores a contents file downloaded in the processing in FIG. 7, which will be described later. In preparing a folder, a folder name having a facility name acquired in step 32 is used as a folder name. FIGS. 4 to 6 exemplify a folder to be prepared, respectively. FIG. 4 illustrates an example with the facility name used as a folder name. A folder of “Facility A” stores a contents file of “File A”, “File B” and “File C”. According to this example, when a vehicle stops once in Facility A in which a roadside device 22 is installed and views information and then stops in Facility A again, the folder of Facility A is newly overwritten and prepared and hence all the file in the folder are erased.

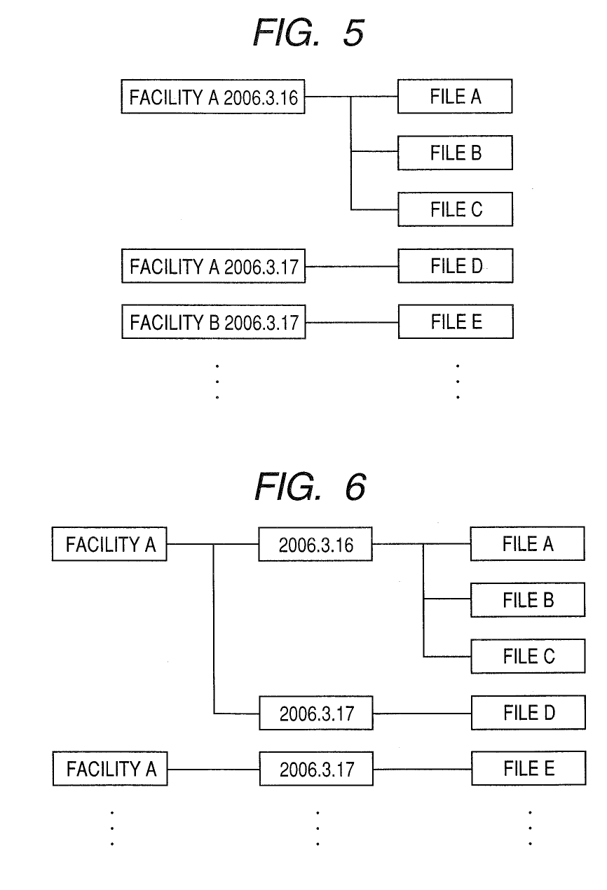

In an example of FIG. 5, for a facility name, the folder name added with a date of a folder preparation date is used as a folder name. In this case, even if information viewing is performed again in Facility A, a different date prepares another folder of the Facility A. In that case, the content of an earlier folder will not be erased. In an example of FIG. 6, a folder of a facility name is prepared and, as a lower-order folder thereof, a folder with only a date as a folder name is prepared. Where a folder of the same facility name is already present, only the folder with only the lower-order date as a folder name is prepared. In this case as well, even if information viewing is performed again in Facility A, a different date adds a folder having only a lower-order date and therefore the content of a previously prepared folder will not be erased.

After preparation of a contents storage folder is completed, the navigation processing unit 11 starts browser, is connected to the information server 23 by IP connection based on URL of a start page, requests and acquires information of the start page, and represents the start page at the I/O unit 14. The user can designate and view a page corresponding to a desired URL linking to the page through the browser, or can request download of contents at the page during viewing. When the vehicle 21 goes out of the communication zone without download of contents, a prepared contents storage folder is not required and therefore is erased.

FIG. 7 is a flow chart illustrating download processing of contents in a navigation processing unit 11. In this processing, when it has been detected that there is an instruction of contents download in step 71, processing moves to step 72, URL corresponding to the instruction is identified, provision of the contents is requested for the information server 23 and, corresponding thereto, a contents file transmitted from the information server 23 is downloaded.

Next, the downloaded contents file is stored in the folder prepared by the processing in step 33 of FIG. 3. Hence, download of the contents is completed.

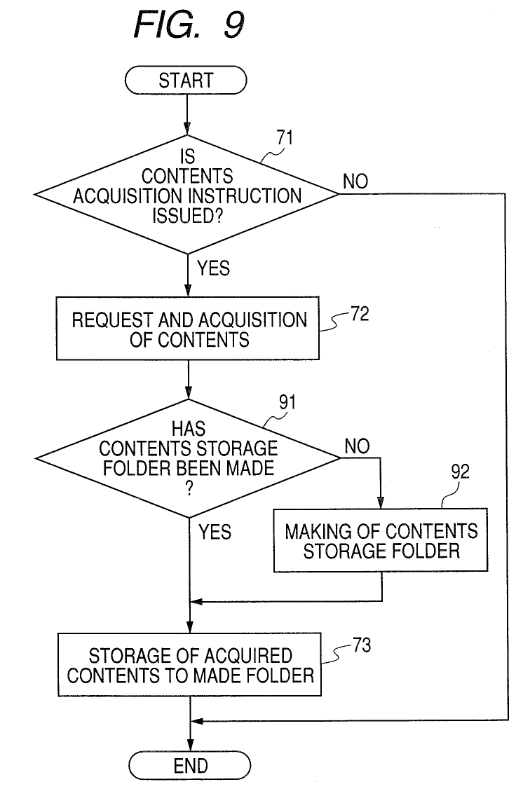

In the above processing, as described above, distribution of an initial URL is received and upon acquisition of a facility name, contents storage folder is prepared (step 33 in FIG. 3) and, in the case of no contents download, the prepared folded is required to be erased. Accordingly, to avoid erasing of the folder, steps 91 and 92 may be added for the processing in FIG. 7 as illustrated in FIG. 9 in place of step 33 in FIG. 3. In this case, the contents file is downloaded (step 72) and, only when it is determined that a contents storage folder has not been prepared (step 91), a contents storage folder is prepared (step 92). Accordingly, a folder storing no contents file is not prepared nor erasing such a folder is required.

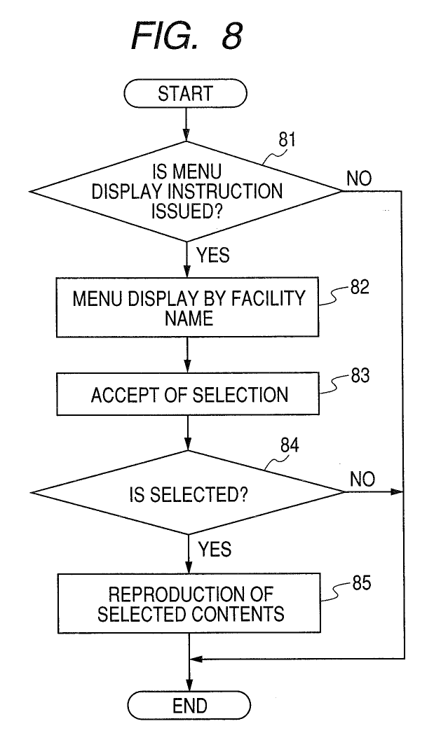

FIG. 8 is a flow chart illustrating contents reproduction processing in a navigation processing unit 11. According to this processing, when it has been detected that an instruction of a menu display for selecting contents to be reproduced has been made in step 81, the menu display is made in step 82. As a selection item in a menu, a facility name can be displayed. For example, in the case of examples of FIGS. 4 to 6, selection items such as “Facility A” and “Facility B” are displayed.

Next, in step 83, when selection of a facility name is accepted and any of facility names is selected, a file name of a contents file stored in a folder having the facility name, for example, “File A” or “File B” is displayed as a selection item and the selection of the contents file is accepted.

Next, in step 84, it is determined whether or not selection of the contents file is made and, when it is determined that no selection is made, contents reproduction is completed. When it is determined that selection is made, reproduction of selected contents is started in step 85. Hence, contents reproduction is completed.

According to the present embodiment, a folder having a folder name using the name of a facility corresponding to a communication zone of the roadside device 22 is prepared and the contents file downloaded through the roadside device 22 is stored in the folder, thus facilitating search of the downloaded contents in the communication zone of the facility.

The present invention can be implemented with deformation as needed without being limited to the foregoing embodiment. For example, in the above description, as a name related to the roadside device 22, a name of a facility existing at a current position of the vehicle 21 is acquired, but in place thereof, a facility name included in URL of a push-distributed start page may be used. In this case, however, in the information server 23, URL to be distributed is required to previously include a facility name. In place of the facility name, a name of landmark, road, place, company or the like may be used. Selection of these names may be selected or set for each communication zone by the user.

Moreover, in the above description, when a re-entry is made into the same communication zone, a folder is identified by date, but in place thereof, date and time may be used so as to identify the folder up to hour, min. and sec. In this case, even if a drop-in is made in the homeward trip on the same day for a communication zone in which a drop-in is made in the outward trip, the contents file downloaded in the outward trip can be maintained without being erased.

Also, in the above description, in a menu display for selecting a contents file, a display of a facility name is used as a selection item (step 82 in FIG. 8), but in place thereof, an icon using a part of image or video data of a contents file stored in a folder of a name using the facility name, for example, data of the first portion of a first file may be used together with a display of a facility name or in place thereof.

Also, in the above description, as a storage method related to a name such as a facility name, of a downloaded contents file, a method for storing in a folder having the facility name as a folder name is used, but in place thereof, the contents file may be stored in a database configured for search with the facility name as a key. The facility name may be written in a metafile of a contents file and stored without being divided into folders. In adopting such storage methods as well, acceptance of selection with a menu display using facility name can be implemented in the same way as in FIG. 8.

Further, in the above description, where a folder having the same name is already present in preparing a new folder, a new folder is prepared by overwriting on an existing folder, but in place thereof, the preparation of the new folder by overwriting or with different name may be configured so that the user can select the preparation way by previous setting or every instruction as needed. The different name can be generated automatically by a predetermined logic or based on a user's instruction.

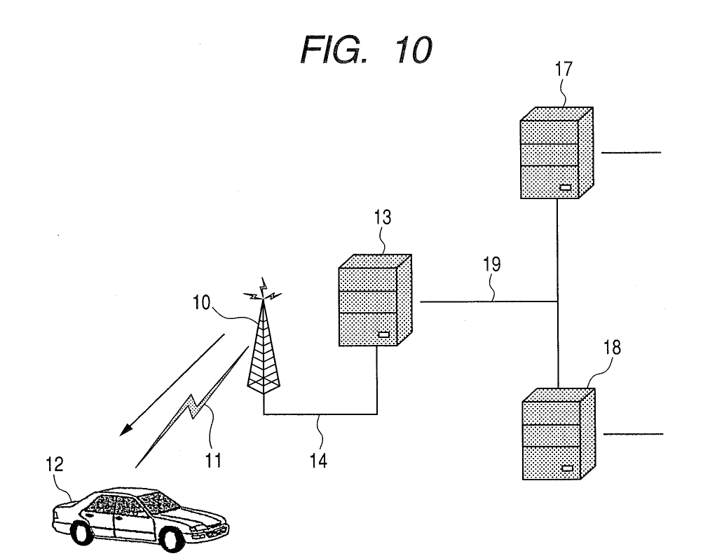

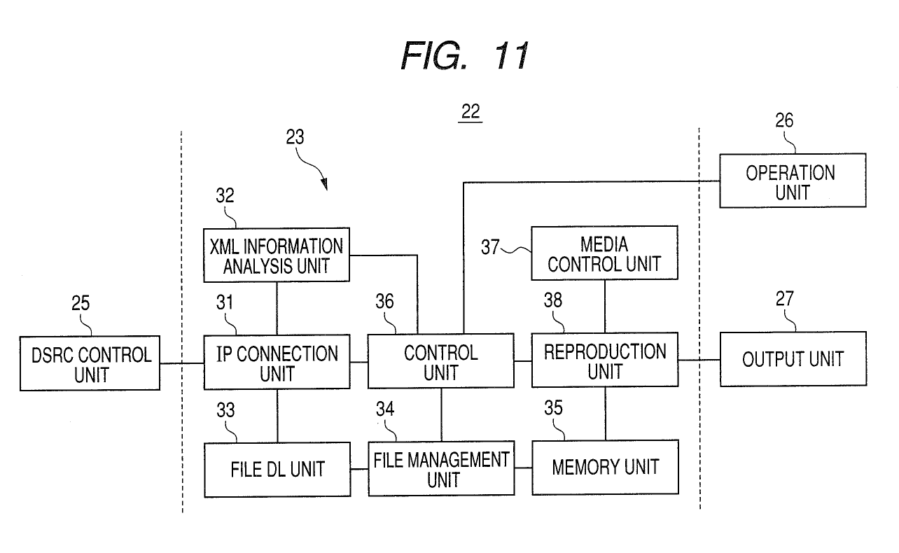

FIG. 10 is a schematic illustrative view of contents file download with a roadside device 10. The roadside device 10 is installed, as needed, at a predetermined position such as a parking space within commercial facilities at a road station or the like or a side or upward of a road, and is configured to make a mutual communication with an in-vehicle unit 22 (FIG. 11) of an automobile 12 through DSRC 11 while parking or passing in vicinity thereof. The in-vehicle unit 22 is provided with an IP address for communication with the roadside device 10.

The server 13 is disposed in a facility managing DSRC 11 and mutually transmits and receives data to/from the roadside device 10 through a fixed line 14. The server 13 is connected with servers 17, 18 outside the facility through an internet 19. Accordingly, the in-vehicle unit 22 of the automobile 12 acquires not only facilities and regional message information from the server 13 but also a contents file of an Entertainment system such as tune from a music server on the internet 19.

FIG. 11 is a configurative view of an in-vehicle unit 22. The in-vehicle unit 22 includes a main body 23 stored in one housing, a DSRC control unit 25 which is outside the main body 23 and connected to the main body 23, an operation unit 26 and an output unit 27. The main body 23 includes an IP connection unit 31, an XML information analysis unit 32, a file DL (download) unit 33, a file management unit 34, a memory unit 35, a control unit 36, a media control unit 37 and a reproduction unit 38.

The DSRC control unit 25 controls communication with the roadside device 10 through DSRC 11. The operation unit 26 is operated for the user to input operational information and specifically, is a touch panel, hardkeys and/or a remote control. The output unit 27 outputs the information of the reproduction unit 38 and specifically is a speaker and/or a monitor.

The IP connection unit 31 executes IP connection with servers 13, 17, 18 in accordance with TCP/IP protocol. The XML information analysis unit 32 downloads and analyzes an XML file from the roadside device 10. The file DL unit 33 downloads a contents file from the roadside device 10.

The memory unit 35, formed from hard disk, stores a downloaded contents file. The file management unit 34 retrieves the contents file stored in the memory unit 35 according to the conditions and executes file management such as preparation of a list of retrieved contents files. The control unit 36 executes calculation corresponding to various types of inputs thereinto and controls various types of elements to be controlled in the in-vehicle unit 22.

The media control unit 37 controls media such as CD or DVD charged into the reproduction unit 38 by the user as needed. The reproduction unit 38 reproduces a predetermined tune or chapter recorded in the media being charged and outputs a reproduction signal to the output unit 27. The reproduction unit 38 reproduces the contents file recorded into the memory unit 35 and outputs the reproduction signal into the output unit 27.

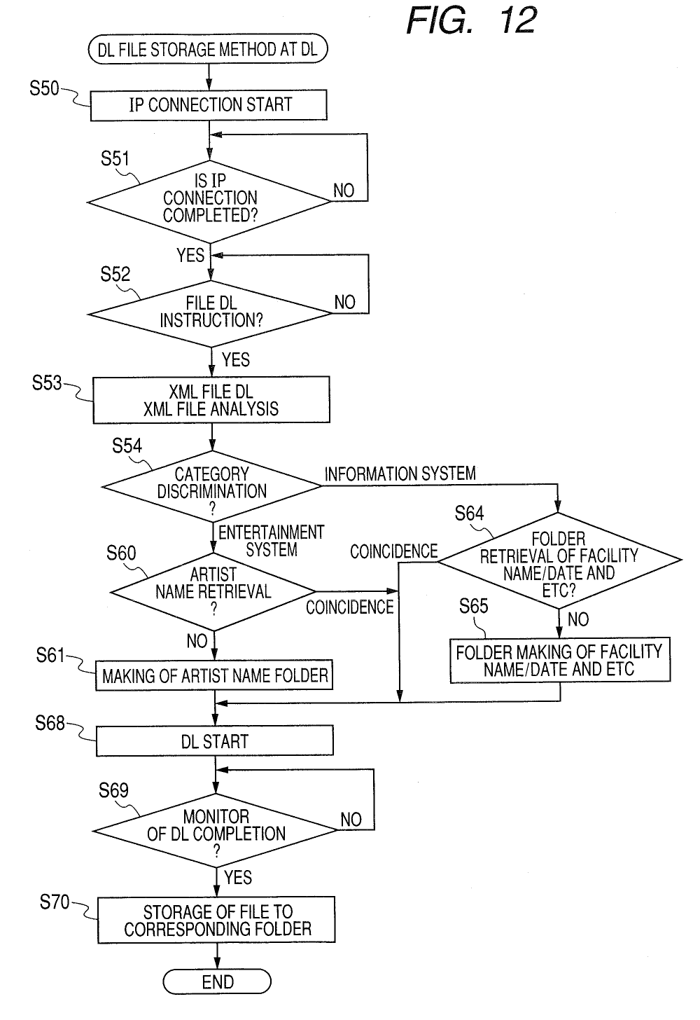

FIG. 12 is a flow chart for DL file storage method at DL (download) in an in-vehicle unit 22. In S50, the automobile 12 enters a point capable of DSRC 11 for the roadside device 10 and starts IP connection to the roadside device 10. In S51, completion of IP connection is monitored and upon the completion, the process moves to S52.

In S52, a download instruction of the contents file is monitored and upon detection of the instruction, the process moves to S53. In S53, after XML (Extensible Markup Language) file is downloaded, the XML file is analyzed. For analysis of the XML, for example, XML parser is used.

In S54, based on XML analysis contents in S53, a category of a contents file to be downloaded is discriminated. Where the discriminated category is among an Entertainment system such as a music file or motion picture distribution file, the process moves to S60. On the other hand, where the category is among Information system such as facility information, weather information and traffic information, the process moves to S64. In FIGS. 12 to 17, for convenience of description, as a contents file of Entertainment system, for example, a music file is estimated and, as a contents file of Information system, for example, an information file of the facility is estimated.

In S60, based on the XML analysis contents in S53, an artist name according to a tune file to be downloaded is discriminated and further it is retrieved whether or not a folder of the corresponding artist name is already present in the memory unit 35. When the folder is present, the process moves to S68, skipping S61 and, if not present, the process moves to S61. The folder of the artist name in the memory unit 35 may be prepared when the user sets a CD tune into the reproduction unit 38 and a tune is ripped from the CD. Traveling from S60 to S68 prevents the folder of the same artist name from being overlappingly prepared in the memory unit 35.

In S61, a folder of the artist name of an XML analysis content in S53 is prepared. In S61, an album name is further extracted from the XML analysis content in S53 and a folder of the album name may be prepared at a lower hierarchy a folder of the artist name by one rank together with a folder of the artist name.

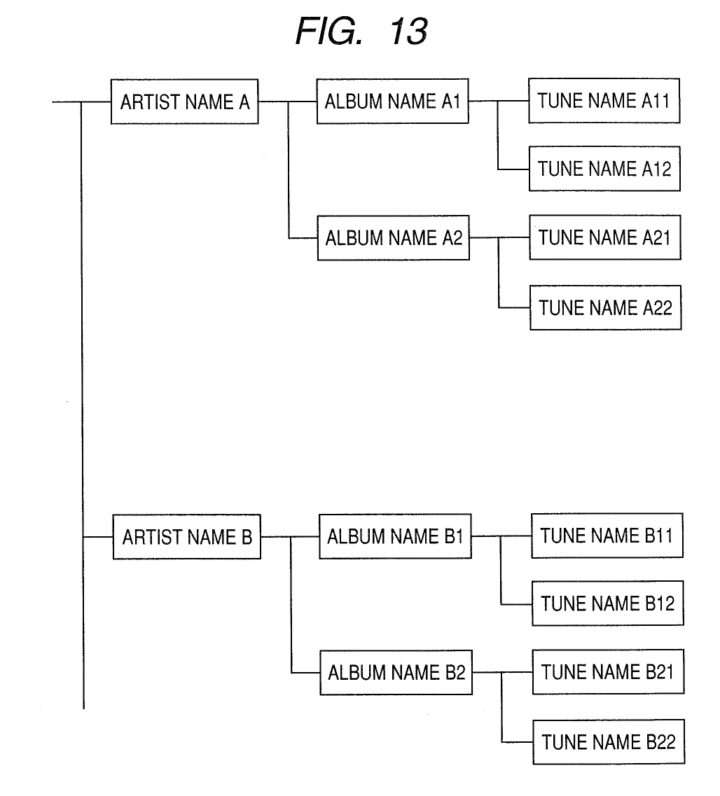

FIG. 13 illustrates a folder configuration prepared in a memory unit 35 when a contents file to be downloaded is a tune file. A folder in which the artist name is taken as a folder name is prepared under a route for each artist. Further, under the folder of each artist name, a folder in which an album name of each artist is taken as a folder name is prepared. Only a folder of the artist name may be prepared with the folder of the album name omitted and a tune file may be stored directly in the folder of the corresponding artist name. Otherwise, only the folder of the album name may be prepared with the folder of the artist name omitted and the tune file may be stored in the folder of the corresponding album name.

Referring to FIG. 12 again, processing contents in S64, S65 are the same as the ones described above on FIGS. 1 to 9. Processing contents in S64, S65 will be schematically described below. In S64, it is retrieved whether or not the folder of the folder name corresponding to the name related to the roadside device 10 is already present. If present, the process moves to S68, skipping S65 and, if present, the process moves to S65. In S65, a folder of the name related to the roadside device 10 is prepared in the memory unit 35.

Main concrete examples of related names of the roadside device 10 are as follows: (a) a place name (all of the address are not necessary and a part of the address, such as town name except names of city, town and village, may be used.) or a facility name, (b) URL of a server displaying the distribution source of a contents file and (c) a name of a distribution source of a contents file.

For the place name or facility name of (a), for example, a current place is detected at download of a contents file and the address of the current place and a facility name can be extracted for detection from a map database of a car navigation system installed on the automobile 12. Further, the facility name can be retrieved for detection from the address of a present place with town information. The URL of (b) and the distribution source name of (c) can be detected from a header of an IP packet for conveying contents file. The information according to (a) to (c) may be included in the XML file downloaded in S53.

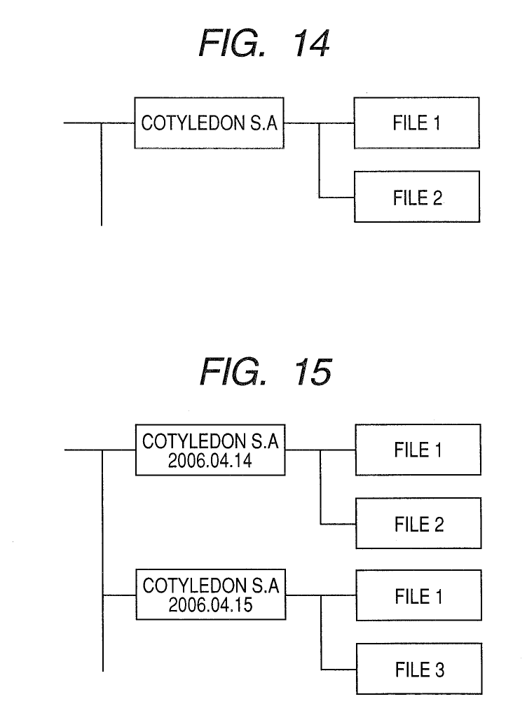

FIG. 14 illustrates a first folder configuration example prepared in the memory unit 35 for a contents file of a category of Information system. Under the route, as a name related to the roadside device 10, a folder having a name of a facility in which the roadside device 10 is installed (in an example of FIG. 14, “Futaba S.A”) as a folder name is prepared. All contents file downloaded from the same roadside device 10 are stored in a folder having a folder name: “Futaba S.A”.

In a folder structure of FIG. 14, when the in-vehicle unit 22 downloads a facility information file of the same file name from the same roadside device 10, an old facility information file is overwritten to be erased. Some users leave the old facility information file without discarding the file.

FIG. 15 is a second folder configuration example prepared in a memory unit 35 for a contents file of a category of Information system. The folder structure of FIG. 15 will be described on differences from that of FIG. 14. In the folder structure of FIG. 15, the folder name is taken as built facility name of roadside device 10+download date. Accordingly, even when the facility information file of the same file name is downloaded from the same roadside device 10, a new facility information file is stored in a folder different from the folder stored with an old facility information file if date is different, thus keeping a past facility information file even after the latest facility information file is downloaded.

In the folder structure of FIG. 15, folder name=built facility name of roadside device 10+download date is hold, but by adding download time, folder name=built facility name of roadside device 10+download date+download time may be used. By doing so, the user, even if visiting the same facility at a different time on the same day and downloading a facility information file of the same file name from the same roadside device 10, relieves a facility information file of old time on the same date from being overwritten and can perform reproduction as needed.

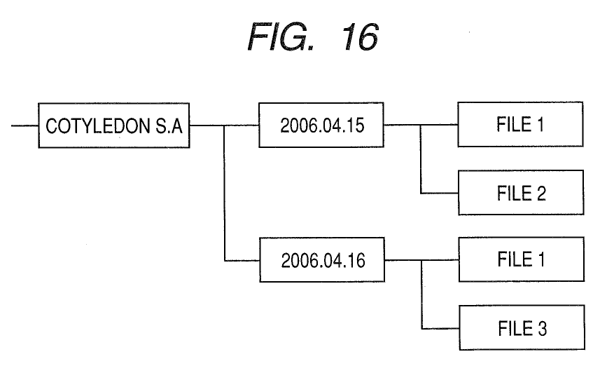

FIG. 16 is a third folder configuration example prepared in a memory unit 35 for a contents file of a category of Information system. The folder structure of FIG. 16 will be described on differences from that of FIG. 15. In the folder structure of FIG. 15, with folder name=built facility name of roadside device 10+download date, a folder structure of a first layer is built. In the folder structure of FIG. 16, under a folder of folder name=built facility name of roadside device 10, a folder of folder name=download date is prepared, and the facility information file downloaded on a different date from the same roadside 10 is stored in each child folder with a different download date as a folder name while a folder of folder name=built facility name of the roadside device 10 is being taken as a common parent folder.

The folder structure of FIG. 16, in the same way as that of FIG. 15, even if it is a contents file having the same name downloaded from the same roadside device 10, a new contents file is stored in the memory unit 35 without an old contents file being overwritten if the download date is different and therefore the contents file having older date can be reproduced as needed even after the latest contents file is downloaded. In the folder structure of FIG. 16, the whole number of folders increases more than in the folder structure of FIG. 15, but the facility information file downloaded on a different date from the same roadside device is organized into a folder having a built facility name of the roadside device 10 as a folder name, thus efficiently detecting a facility information file from a targeted roadside device.

Referring to FIG. 12 again, in S68, download of a contents file is started from the roadside device 10. The downloaded contents file is stored in a temporary memory such as RAM. In S69, it is monitored whether or not download is completed and, upon the completion, the process moves to S70.

In S70, the contents file in RAM is moved into the corresponding folder. The corresponding folder in S70 is a new folder when a folder is newly prepared in S61 or S65. When a folder of an artist name or facility name corresponding upon completion of S54 is already prepared, the file is a folder already prepared.

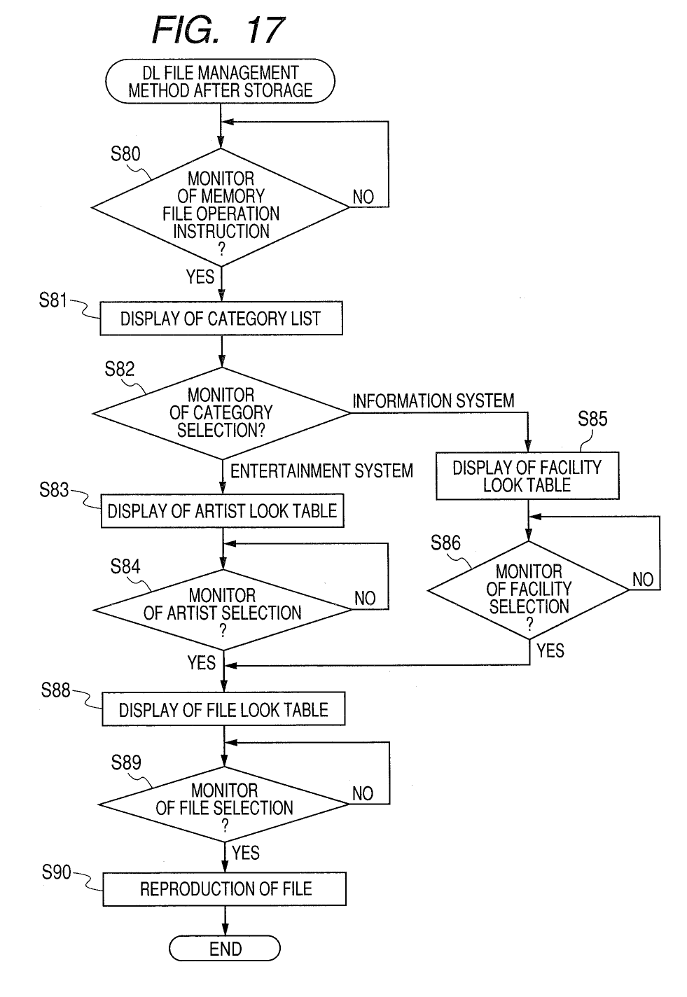

FIG. 17 is a flow chart of a management method for DL file stored in a memory unit 35 based on the DL file storage method in FIG. 12. In S80, it is monitored whether or not the user performs an operational instruction according to a recording file in the memory unit 35 or not. Upon detection of the operational instruction, the process moves to S81. In S81, a category list is displayed on a monitor of the output unit 27.

In S82, category selection from the category list by the user is monitored and the selected category is discriminated. When the user selects Entertainment system category, the process moves to S83. On the other hand, when the user selects the Information system category, the process moves to S85.

In S83, an artist look table is displayed on a monitor of the output unit 27. In S84, it is monitored whether or not the user selects an artist from the artist list. Upon the selection, the process moves to S88.

In S85, displays a facility look table on the monitor of the output unit 27. In S86, it is monitored whether the user has selected a facility from the facility look table or not. Upon selection, the process moves to S88.

In S88, displays the look table of the contents files belonging to the artist or the facility selected by the user in S84 or S86 is displayed on the monitor. In the folder structures in FIGS. 13 and 16 described above, the folder corresponding to each artist or each facility has folders corresponding to the albums of the same artist or the dates of the same facility therebelow, but S88 omits the folders of album name in FIG. 13 in processing or performs processing for folders for single hierarchy in FIG. 14 or FIG. 15. In the event of a folder structure with a multi-hierarchy, the folder name look table of the lower-class hierarchy is displayed on the monitor, S88 is executed after the user selects one folder name from the folder name look table.

In S89, it is monitored whether or not the user selects a file from a file look table or not. When the user selects a file from the file look table, the process moves to go to S90. In S90, the file selected by the user is reproduced.

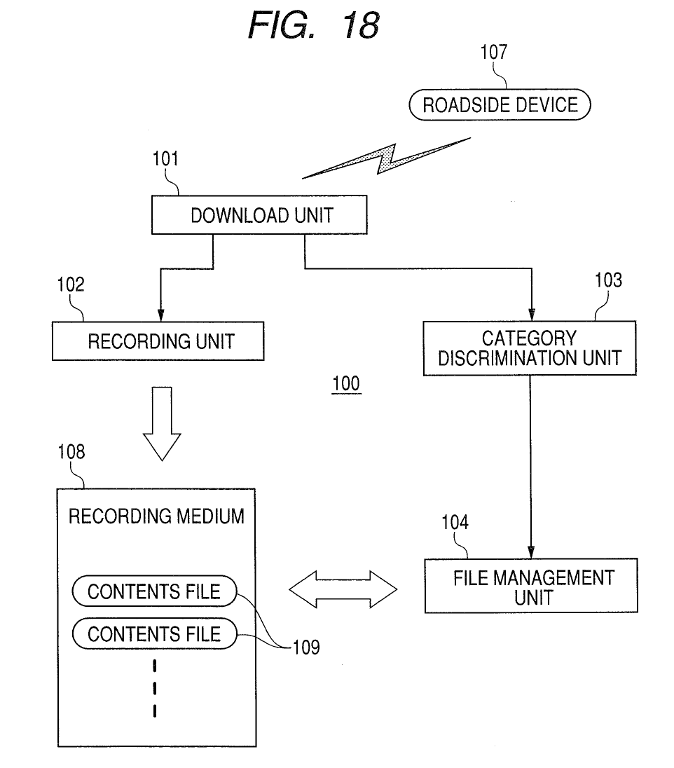

FIG. 18 is a block diagram of contents file processing device 100 for mounting in a vehicle. The in-vehicle unit 22 is an embodiment of the contents file processing device 100 for mounting in a vehicle. The contents file processing device 100 for mounting in a vehicle is provided with a download unit 101, a recording unit 102, a category discrimination unit 103 and a file management unit 104.

The download unit 101 downloads a contents file 109 and the content information of the contents file 109 from a roadside device 107. The recording unit 102 records the downloaded contents file 109 in a recording medium 108. The category discrimination unit 103 discriminates the category of the contents file 109 based on the contents information. The file management unit 104 manages the contents file 109 downloaded and recorded in the recording medium 108 based on the category of the contents file 109.

The contents file 109 and the contents information is downloaded from the roadside device 107 to the download unit 101 through the DSRC or the like. The contents information is typically downloaded to the download unit 101 prior to the contents file 109, however, may be downloaded concurrently with or after the contents file 109. When the contents information is downloaded concurrently with or after the contents file 109, the contents file 109 downloaded to the download unit 101, for example, is temporarily recorded in a temporary recording unit and transferred to the recording medium 108 after the contents information is downloaded and analyzed.

The categories of the contents file 109 include at least the Entertainment system category and the Information system category. The contents file 109 of the Entertainment system category may be an audio file such as a tune, a video file including video only, or a video file including both video and audio. The Information system contents file 109 is, for instance, the merchandise information of shops inside a facility and the notification of roads, weather conditions, events or the like in the vicinities of the facility.

Preferably, the download unit 101 downloads the contents information in an XML file. Typically, the download unit 101 communicates with the roadside device 107 in IP connection. The contents information may be included on the header of an IP packet for transmitting the contents file 109.

Typically, as illustrated in FIGS. 13 to 16, a file management unit 104 manages each contents file 109 based on the name of the folder in which the contents file 109 is stored in a recording medium 108. The file management unit 104 causes a recording unit 102 to make a folder named corresponding to each of the categories of the contents files 109, thereby storing the downloaded contents file 109 in the folder corresponding to the category.

Managing the contents file 109 by the name of the folder in which the contents file 109 is stored enables each contents file 109 in the recording medium 108 to be identified and accessed under a path in which the folder name of each hierarchy is stringed from a route toward the low-class hierarchy.

Preferably, contents information on the contents file 109 of an Entertainment system category includes not only the category of the contents file 109 but also information relating to classification in the category (also designated as a subcategory). Further, the recording unit 102 extracts the classification name of the contents file 109 of the Entertainment system category from the contents information to make a folder of which name is the classification name. When the contents file 109 is a tune file, the classification name of the contents file 109 of the Entertainment system category is, for example, the artist name and the album name described in FIG. 13, besides when the contents file 109 belonging to the Entertainment system category is a video file, the classification name is the title and the chapter.

As compared to the contents files 109 of the Entertainment system, in the case of the contents file 109 of an Information system category, for instance, the name of a folder for storing the contents file 109 relates to a roadside device 107 of the distribution origin of the contents file 109 as described in FIGS. 14 to 16. Although the folder name is the facility name mounted with the roadside device 107 in FIGS. 14 to 16, the address mounted on the roadside device 107, the URL of the distribution origin of the contents file 109, the distribution origin name or the like are additionally available.

The address of the contents file 109 can include all of the address from the prefecture name to the number, a part of the address such as the location name (e.g. Nihonbashi), the municipal name+the location name (e.g. Chuo-ku, Nihonbashi), or the prefectural name+the municipal name+the location name (e.g. Tokyo-to, Chuo-ku, Nihonbashi. In this case, the number is omitted). The URL of the distribution origin of the contents file 109 is completed on the header of an IP packet downloaded from the roadside device 107 to the download unit 101. The address of the contents file 109, for instance, is detected by checking a present location upon downloading against a map on a map database.

The recording unit 102 hierarchically structures the classification extracted from the contents information regarding the contents file 109 of Entertainment system category to make folders based on a hierarchical structure corresponding to the hierarchical structure of the classification. The embodiment of the folders in the hierarchical structure is shown in FIG. 13. As illustrated in FIG. 16, the hierarchically structuring of the folders is applied to the file management system on the contents file 109 of Information system category.

The file management system by the file management unit 104 for the contents file 109 of Entertainment system category downloaded from the roadside device 107 is preferably integrated with the file management system applied to the contents file 109 of Entertainment system category ripped into the recording medium 108 from a removable different recording medium. This enables the user's operational environment to be integrated regardless of whether contents file 109 of Entertainment system is downloaded or ripped from the roadside device 107.

The recording medium 108 is typically a hard disk device, but may be a non-volatile recording unit such as a bulk flash memory. The removable different recording medium includes a CD and a DVD as an example.

As the file management system on the contents file 109 of the Entertainment category, apart from the folder name management, the file management unit 104 may make a database based on the contents information of the contents file 109 of the Entertainment system category downloaded from the roadside device 107 and manage the contents file 109 by the database.

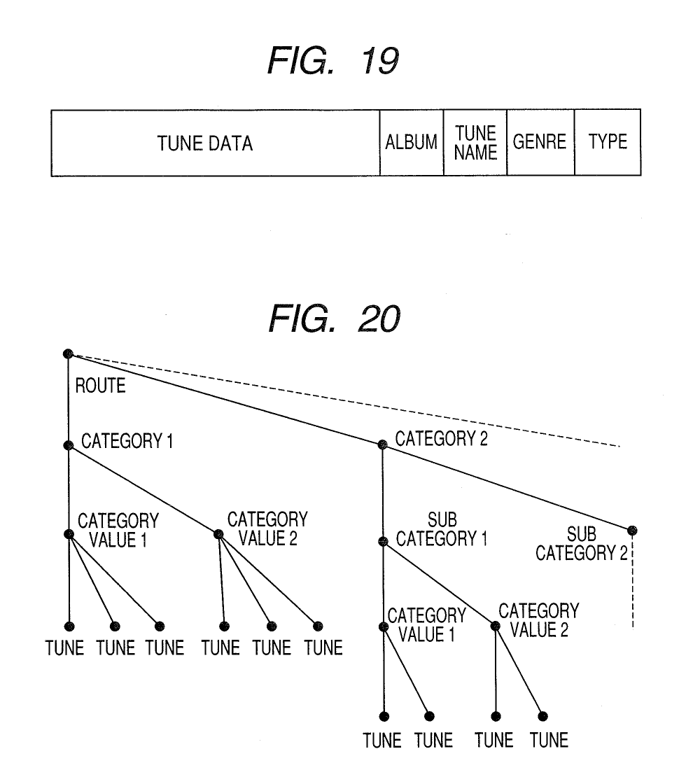

Now, an embodiment on the database management will be described below. FIG. 19 is the structural drawing of the contents file including metadata. The contents of the contents file in FIG. 19 are the tunes of Entertainment system category, but the file structure in FIG. 19 is applicable to the file of Information system category.

In the structure in FIG. 19, the tune data as contents data is arranged at the top of the file and followed by the metadata. In this embodiment, four attributes concerning the tune as the metadata are defined and the album, the tune name, the genre and the type associated with the tune are arranged in a sequential order from the top. Because the attributes are freely defined, the artist name and the national origin of the artist can be defined.

FIG. 20 illustrates a database constructed using the metadata of the contents file. The low-class hierarchal categories under a route are named as category 1, 2 . . . . The categories 1, 2 are, for example, the album name and the artist name.

Category values 1, 2 in the lower-class hierarchy under the category 1 are, for instance, Abbey Road and Hits of the 60's. In this embodiment, three tunes are respectively linked under the category values 1, 2. The tunes linked under the category value 1 are, for example, Golden Slumbers, Something and Sun King.

For example, subcategories 1, 2 in the low-class hierarchy under the category 2 respectively set the U.K and the U.S.A as the national origin of respective artists. The category values 1, 2 in the low-class hierarchy under the subcategory 1 are, for instance, Beatles and Petula Clark. In this embodiment, a plurality of tunes are respectively linked under the category values 1, 2. The tunes linked under the category value 1 are Golden Slumbers, Something and Sun King as an example.

In the database construction shown in FIG. 20, the category and the subcategory of which each contents corresponds are found from the metadata of the contents and registered as the leaves of all the corresponding categories and subcategories. Therefore, the same contents belong to a plurality of categories and subcategories. In the above-mentioned embodiment on the tunes, the Golden Slumbers belongs to the category value 1 (Abbey Road) of the category 1 (album) and the category value 1 (Beatles) of the subcategory 1 (artists from the U.K) of the category 2 (artist) in registration.

Thus, the contents file processing device 100 for mounting in a vehicle manages each contents file 109 in the appropriate file management system corresponding to the category of the downloaded contents file 109, thereby enabling the user to effectively search the desired contents file 109 upon reproducing the contents file 109.

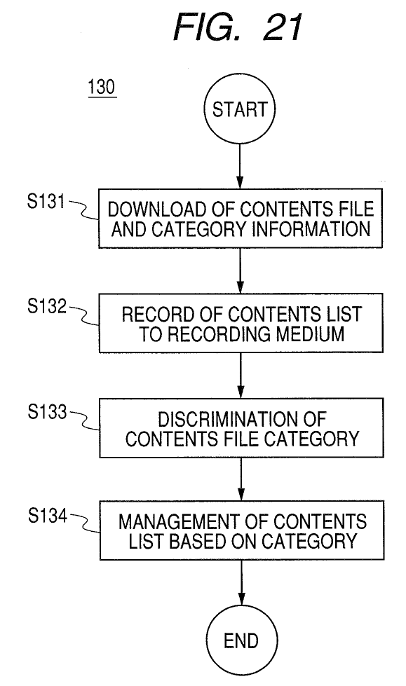

FIG. 21 is the flow chart showing a contents file processing method 130 for mounting in a vehicle. For example, the contents file processing method 130 for mounting in a vehicle is applied to the contents file processing device 100 for mounting in a vehicle. The contents file processing method 130 for mounting in a vehicle includes at least S131 to S134. S132 may be executed between S133 and S134. The method described through the use of the flow charts in FIGS. 11 and 17 is the embodiment of the contents file processing method 130 for mounting in a vehicle.

In S131, the contents file 109 and the contents information of the contents file 109 are downloaded from the roadside device 107. In S132, the downloaded contents file 109 is recorded in the recording medium. In S133, the category of the contents file 109 is discriminated based on the contents information. In 134, the contents file 109, which is downloaded and recorded in the recording medium, is managed based on the category of the contents file 109.

The specific aspect described on the contents file processing device 100 for mounting in a vehicle is also applied to the specific aspect of the contents file processing method 130 for mounting in a vehicle as appropriate. In this case, each specific aspect applied to the download unit 101, the recording unit 102, the category discrimination unit 103 and the file management unit 104 becomes each specific aspect of S131, S132, S133 and S134 in principle.

For example, in S134, each contents file 109 is managed based on the name of the folder in which the contents file 109 is stored in the recording medium. Correspondingly, in S132, a folder named corresponding to the category of the contents file 109 is made, thereby storing the downloaded contents file 109 in the folder corresponding to the category.

For example, the category of the contents files includes at least Entertainment system category and Information system category. The contents information on the contents file 109 of Entertainment system category includes the category of the contents file 109 together with the information referring to the classification in the category. In S132, the classification name of the contents file 109 of Entertainment system category is extracted from the contents information to make a folder with the same name as the classification name.

For example, in S132, the classification extracted from the contents information of the contents file 109 of Entertainment system category is hierarchically structured to make folders with a hierarchal structure corresponding to the hierarchal structure of the classification.

For instance, the file management system in S134 regarding the contents file 109 of Entertainment system category downloaded from the roadside device 107 is integrated with the file management system applied to the contents file 109 of Entertainment system category ripped from the removable different recording medium to the recording medium.

For example, the name of a folder for storing the contents file 109 of the Information system category is related to the roadside device 107 of the distribution origin of the contents file 109.

The file management system in S134 may make a database based on the contents information of the contents file 109 of Entertainment system category downloaded from the roadside device 107 and manage the contents file 109 by the database.

For instance, in S131, the contents information of the contents file 109 is downloaded prior to the contents file 109 and the category discrimination unit detects the category of the contents file 109 before the contents file 109 is downloaded. For example, in S131, the contents information is downloaded as the XML file.

A program to which the present invention is applied causes a computer to be functioned as each unit of the contents file processing device 100 for mounting in a vehicle. Another program to which the present invention is applied makes the computer execute each step of the contents file processing method 130 for mounting in a vehicle.

The present invention has been described on various types of embodiments, but is not limited thereto. Various changes and modifications (including deletion) in respective components may be made in various types of embodiments of the invention without departing from the spirit and scope thereof. Further, various types of inventions may be formed from substitution of components between various types of embodiments or combinations of a plurality of components in various types of embodiments.

1. A contents file processing device for mounting in a vehicle, in which communication is established between a roadside device installed on a road side and the vehicle, comprising:
a name acquisition unit for acquiring a name related to the roadside device;
a download unit for downloading a specified contents file from a predetermined server through the roadside device; and
a recording unit for recording the contents file downloaded by the download unit, so that the file is associated with the name acquired by the name acquisition unit.

2. The contents file processing device for mounting in a vehicle according to claim 1, characterized in that the name acquisition unit acquires a predetermined name included in a descriptive mode distributed through the roadside device as a name related to the roadside device.

3. The contents file processing device for mounting in a vehicle according to claim 1, characterized in that the name acquisition unit acquires a name related to the acquired position from a map database based on the acquired position.

4. The contents file processing device for mounting in a vehicle according to claim 1, further comprising a folder preparation unit for preparing a folder having a folder name using a name acquired by the name acquisition unit, characterized in that
the recording unit records a contents file downloaded by the download unit in a folder prepared by the folder preparation unit.

5. The contents file processing device for mounting in a vehicle according to claim 4, characterized in that the folder preparation unit includes information of a date or date and time at preparation in a folder name.

6. The contents file processing device for mounting in a vehicle according to claim 4, characterized in that the folder preparation unit prepares a subfolder containing information of a date or a date and time at preparation in a folder using the name and that the recording unit records the contents file for a subfolder prepared by the folder preparation unit.

7. The contents file processing device for mounting in a vehicle according to claim 4, further comprising a unit for arranging an icon configured based on image data or a part of image data among contents files stored in the folder on a predetermined menu screen.

8. A contents file processing device for mounting in a vehicle, in which communication is established between a roadside device installed on a road side and the vehicle, comprising:
a download unit for downloading a contents file and contents information of the contents file from a roadside device;
a recording unit for recording a downloaded contents file to a recording medium;
a category discrimination unit for discriminating a category of the contents file based on the contents information; and
a file management unit for managing a contents file downloaded and recorded to a recording medium based on a category of the contents file.

9. The contents file processing device for mounting in a vehicle according to claim 8, characterized in that a category of a contents file includes at least a category of an Entertainment system and a category of Information system.

10. The contents file processing device for mounting in a vehicle according to claim 9, characterized in that:
the file management unit manages respective contents files based on a name of a folder in which the content file is stored in the recording medium, and the file management unit makes the recording unit prepare a folder of a corresponding name for each category of a contents file and store a downloaded contents file in a corresponding folder for each category.

11. The contents file processing device for mounting in a vehicle according to claim 10, characterized in that contents information about a contents file of a category for Entertainment system includes a category of a contents file and information according to a classification within the category, and the recording unit extracts a name of a class of the contents file from the contents information and prepare a folder having a class name as a folder name for a contents file of a category for an Entertainment system.

12. The contents file processing device for mounting in a vehicle according to claim 11, characterized in that the recording unit hierarchy-structures a class extracted from the contents information and prepares a folder from a hierarchy structure correlated with the hierarchy structure of the class for a contents file of a category of an Entertainment system.

13. The contents file processing device for mounting in a vehicle according to claim 9, characterized in that a file management system by the file management unit for a contents file of a category for an Entertainment system downloaded from a roadside device is unified with the file management system applied to a contents file of a category for an Entertainment system ripped to the recording medium from another recording medium.

14. The contents file processing device for mounting in a vehicle according to claim 10, characterized in that a name of a folder storing a contents file of a category of Information system relates to a roadside device of a transmission source of the contents file.

15. The contents file processing device for mounting in a vehicle according to claim 8, characterized in that the download unit downloads contents information of a contents file earlier than the contents file and downloads the contents file after the category discrimination unit detects a category of the contents file.

16. A contents file processing method using a contents file processing device for mounting in a vehicle, comprising:
acquiring a name related to roadside device;
downloading a specified contents file from a predetermined server through the roadside device; and
recording a contents file downloaded during the download, associated with a name acquired during the name acquisition.

17. A contents file processing method using a contents file processing device for mounting in a vehicle, comprising:
downloading a contents file and contents information of the contents file from roadside device;
recording downloaded contents file to a recording medium;
discriminating a category of the contents file based on the contents information; and
managing an downloaded contents file recorded to a recording medium based on a category of the contents file.

18. A program which causes a computer to execute:
acquiring a name related to a roadside device;
downloading a specified contents file from a specified server through the roadside device; and
recording a contents file downloaded during the downloading, associated with a name acquired during the name acquisition.

19. A program which causes a computer to execute:
downloading contents file and contents information of the contents file from roadside device;
recording a downloaded contents file to a recording medium;
discriminating a category of the contents file based on the contents information; and
managing an downloaded contents file recorded to a recording medium based on a category of the contents file.
